(19) United States
(12) Patent Application Publication
(10) Pub. No.: US 2012/0153200 A1
(43) Pub. Date: Jun. 21, 2012

(54) DEVICE FOR CONTROLLING THE SUPPLY OF A COMBUSTIBLE GAS TO A BURNER, PARTICULARLY FOR WATER HEATERS

(75) Inventors: Gianpiero TURRIN, Padova (IT); Michele BENVENUTO, Mogliano Veneto (TV) (IT)

(73) Assignee: SIT LA PRECISA S.p.A.con socio unico, Padova (IT)

(21) Appl. No.: 13/325,416

(22) Filed: Dec. 14, 2011

(30) Foreign Application Priority Data
Dec. 21, 2010 (IT) PD2010A000385

(51) Int. Cl. F16K 31/02

(52) U.S. Cl. 251/129.15

(57) ABSTRACT

A device is provided for controlling a gas supply to a burner, having a draft shut-off device and includes a main gas supply pipe with first and second servovalves therein, which include respective valve seats associated with corresponding shut-off members with diaphragm control for opening the seats in opposition to a resilient return member. A pilot pipe branched from the main pipe supplies a pilot burner. A thermoelectric magnetic safety unit is provided on the main pipe, acting to allow gas to flow towards the pilot burner when the unit is activated. The draft shut-off device includes a corresponding shut-off member movable from and towards a position in which an exhaust pipe is shut off, and a diaphragm-controlled pneumatic actuator of the shut-off member, the diaphragm forming a corresponding control chamber of the shut-off member which is in fluid communication with an auxiliary pipe section branched from the main pipe.

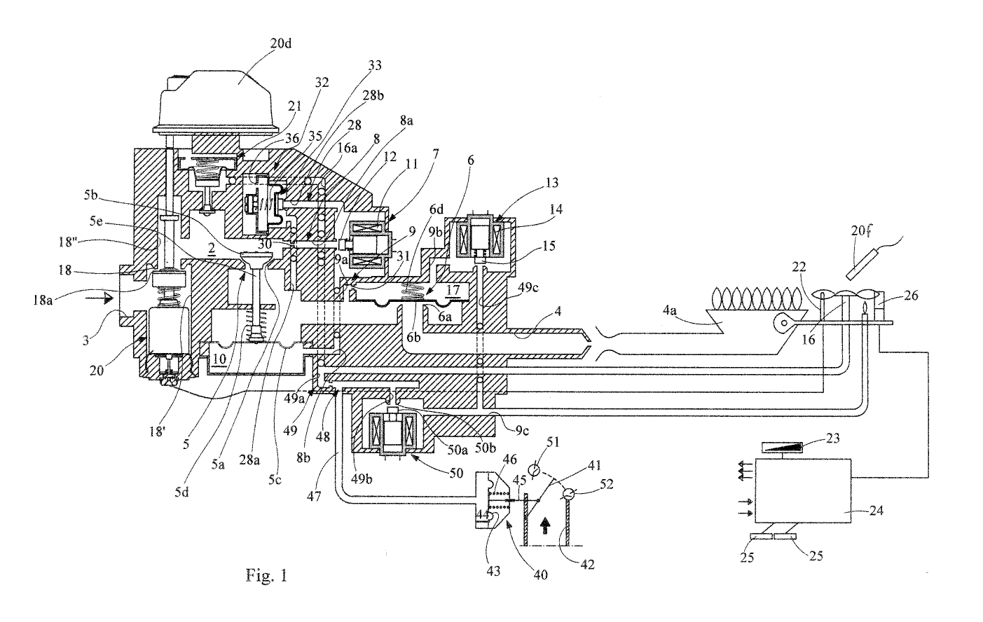

### FIELD OF THE INVENTION

The present invention relates to a device for controlling the supply of a combustible gas to a burner. The invention relates more particularly, but not exclusively, to the field of devices for the multifunctional control of the supply of combustible gas in valve units for use in heaters, particularly domestic water heaters.

### BACKGROUND

In a typical known device of this kind, a thermocouple-controlled magnetic safety unit with a manual activation system is associated with an electromagnetically operated servovalve for controlling a servo-assisted gas circuit (“servo circuit”), the power supply to this system being provided by a thermopile heated in parallel with the thermocouple of the pilot burner.

In other applications, the power required for operation can be obtained from systems for recovering energy from the environment or from the apparatus itself. In particular applications, however, the supply control device has to be provided with a pair of automatic safety valves in order to meet statutory safety requirements. One example is that of domestic water heaters, in which the heater has a draft shut-off valve in the flue, also known as a “flue damper”, which acts as a draft shut-off device in the exhaust fume vent pipe.

In this application, there is a known way of providing a pair of servo-assisted valves, positioned in series along the main gas passage, in which each safety valve (of the on-off type) is an electromagnetically operated servovalve for controlling the corresponding servo circuit. In this configuration, since the electromagnetically operated solenoid valves which control the servo-assistance circuits of the servovalves act by opening and closing small gas passages (in the control circuit), their power absorption is rather small, and therefore they may be considered for use, in this case, with thermoelectric devices for generating the power required for operation, or with equivalent devices.

An example of a valve unit of the aforesaid type is described in Italian patent application PD2010A000089 in the name of the present applicant.

Valve units of the aforesaid type are designed for applications in water heaters provided with draft shut-off devices. In heaters provided with draft shut-off devices, the safety regulations require that each of the servovalves, which are in series with each other, should be controllable to open and close the main gas passage for each heating cycle in a way which is functionally independent of the flame produced by the pilot burner.

There are also known gas supply control devices in which the shut-off member of the draft shut-off device provided in the combustion fume exhaust flue is driven by a powered actuator, which is typically provided with an electric motor supplied with power taken from the electrical mains, from batteries, or from thermoelectric generators such as thermopiles.

This drive system requires an adequate source of power for the operation of the draft shut-off device, which is incompatible with the primary benefit of these devices, namely their substantial independence of power sources outside the device. Furthermore, in the case of thermoelectric generators for producing electrical energy inside the device without external assistance, the power demand for driving the draft shut-off device typically makes the construction of the control device more complicated and expensive.

### SUMMARY

The object of the present invention is to provide a device for controlling the supply of a combustible gas to a burner, particularly for a water heater having draft shut-off device in the combustion fume exhaust, whose structural and functional design is such that the limitations of the aforementioned prior art can be overcome.

This object is achieved by the invention by means of a device for controlling the supply of a combustible gas to a burner, constructed in accordance with the claims set out below.

### BRIEF DESCRIPTION OF THE DRAWING

Other features and advantages of the invention will be made clear by the following detailed description of some preferred embodiments thereof, illustrated, for guidance only and in a non-limiting way, with reference to the appended drawing which shows a schematic view in longitudinal section of an example of a device made according to the present invention.

### DETAILED DESCRIPTION OF THE PREFERRED EMBODIMENT

With reference to the aforesaid drawing, the number 1 indicates the whole of a device for controlling the supply of a combustible gas to a burner apparatus of a domestic water heater, constructed according to the present invention.

The device 1 comprises a valve unit positioned in a main gas supply pipe 2, between a gas inlet section 3 and an outlet section 4 where the gas is supplied to a main burner 4a.

Along the main pipe 2 there are a first and a second servovalve, indicated by 5 and 6 respectively, positioned in cascade with each other in such a way that the servovalve 6 is downstream of the servovalve 5 with respect to the direction of the gas flow supplied through the pipe 2.

Each servovalve 5, 6 comprises a corresponding servo circuit including a corresponding valve seat 5a, 6a associated with a corresponding shut-off member 5b, 6b controlled by a diaphragm 5c, 6c, for opening the seats 5a, 6a in opposition to corresponding resilient return member such as corresponding springs 5d, 6d. Both of the servovalves 5, 6 act as on-off valves for closing the main gas passage for safety reasons, as will be explained in the following description.

The first servovalve 5 is associated with a control solenoid valve for the servo-assistance circuit, indicated by 7, arranged to open or close an auxiliary control pipe 8 of the servo circuit, which forms the intake pipe for the pressure signal to be transmitted to the control chamber of the servo circuit. The diaphragm 5c acts directly on the operating rod 5e of the shut-off member 5b, which is pushed by the spring 5d to close the seat.

One side of the diaphragm 5c delimits a control chamber 10 which communicates with the main pipe 2, upstream of the servovalve 5, through the pipe 8. More specifically, the pipe 8 includes a first part 8a, extending upstream of the solenoid valve 7, and a second part 8b, which is a continuation of the first part, extending downstream of the solenoid valve 7 and communicating with the chamber 10. A constriction 30 is provided in the part 8a of the pipe.

The control chamber 10 is connected to the main pipe 2, downstream of the valve seat 5a of the first servovalve 5, through a corresponding discharge pipe 28, in which a pressure regulator, indicated as a whole by 32, is provided. Alternatively, the discharge pipe 28 can be connected to the main pipe in a section downstream of the second servovalve 6.

The regulator is a diaphragm-type pressure regulator, of a conventional type, in which one side of a diaphragm delimits a control chamber 33 which communicates, through a part 28a of the pipe 28, with the main pipe 2 (downstream of the servovalve 5), and which can also shut off the outlet section of the other part 28b of the pipe 28 communicating with the control chamber 10. The opposite side of the diaphragm is acted on by a calibration spring 35 positioned in a chamber which is open to the atmosphere through an aperture 36. The pressure regulator 32 is designed to react to the variations in the supply pressure and to compensate for these, and also to return the pressure to a calibrated value predetermined by regulating the spring 35. The pressure regulator 32 can also be designed to provide pressure modulation, for example by acting as a modulating regulator operated electromagnetically (by means of a motor or linear actuator) or pneumatically (by means of a diaphragm).

At the position of the solenoid valve 7, the corresponding part of pipe 8 is selectively opened or closed by an electromagnet 11, of the on-off type with a resilient return member, acting on a shut-off member 12 which is associated with the passage cross section of the pipe 8 and which can be moved to and from a position in which the passage cross section is shut off.

A control pipe 9 of the servovalve 6 is branched from the main pipe 2, with which it is in fluid communication, downstream of the valve seat 5a.

More specifically, the pipe 9 comprises a first part 9a, in which there is a constriction 31, extending between the main pipe and a control chamber 17 of the second servovalve, and a second part 9b, departing from the control chamber 17, in which there is a second solenoid valve 13, for the servo-assisted operation of the second servovalve 6.

At the position of the solenoid valve 13, a part 9b of the pipe 9 is selectively opened or closed by an electromagnet 14, of the on-off type with a resilient return member, acting on a shut-off member 15 which is associated with the passage cross section of the pipe part 9b and which can be moved to and from a position in which the passage cross section is shut off.

The pipe 9 acts as an inlet pipe for the pressure signal to be transmitted to the control chamber 17 of the corresponding servo circuit, the chamber 17 being delimited by one side of the diaphragm 6c.

The part 9b of the pipe 9, downstream of the solenoid valve 13, is extended to form a bleed line 9c leading towards the proximity of the main and pilot burners, for the direct combustion of the gas discharged through the pipe 9.

The valve unit of the device according to the invention comprises an auxiliary gas line, branched from the main line, which supplies both a pilot burner 16 and the control circuit of a draft shut-off device acting on the combustion fume exhaust, as detailed in the following description.

The auxiliary line has a pilot pipe 16a which is branched from the main pipe 2, for supplying the pilot burner 16.

Starting from the inlet section, the main pipe 2 includes a first portion 18′ extending into a second portion 18″ through an interposed valve seat 18, which is acted on by a manually activated thermoelectric magnetic safety unit 20, including a shut-off member 18a which is held in the open position of the seat 18 by the energizing of the magnetic unit due to the thermocouple voltage when a flame is present at the pilot burner 16.

The portion 18″ communicates with the main pipe 2, downstream of the seat 18, and with the pilot pipe 8.

The portion 18″, extending downstream of the seat 18, is also connected to the pilot pipe 16a.

The drawing includes a view of the knob 20d from above, showing the operating positions that can be selected (OFF, PILOT, ON).

The knob element 20d is connected to the actuating rod 20c for the manual activation of the safety unit, in a known way, by means of which an igniting device 20f (such as a piezoelectric device) associated with the pilot burner 16 is operated in the activation position (PILOT). The knob 20d can also be switched to the closed position (OFF) in which the valve seat 18 is shut off by the corresponding shut-off member of the magnetic safety unit.

The number 21 indicates a diaphragm-controlled pressure regulator for regulating the gas pressure in the pilot pipe 16a which supplies the pilot burner 16. The valve unit also comprises a thermocouple 22 associated for operation with the pilot burner 16.

The number 23 indicates a temperature selection knob, associated for operation with a circuit on an electronic control board 24 which can process the incoming signals on the basis of preselected programs and operating modes, in order to supply the control signals to the servovalves 5, 6. The signals entering the circuit board 24 include those sent by one or more temperature sensors 25. A thermopile 26, associated in a suitable way with the pilot burner 16, is provided for the supply of power to the electronic circuit board 24.

Alternatively, means can be provided for recovering electrical energy from the apparatus itself or from the environment (using photovoltaic cells, microturbines, or the like) for supplying the circuit board 24.

The draft shut-off device, indicated as a whole by 40 and shown in a purely schematic way in the drawing, is provided to shut off, in a selective manner, the combustion fume exhaust pipe which is adapted to discharge the exhaust gases from the combustion chamber in which the pilot and main burners are positioned. The draft shut-off device 40 comprises a shut-off member 41 which is movable from and to a position in which the exhaust pipe is shut off, represented in a partial way and indicated by 42, and diaphragm-operated pneumatic actuator 43 for actuating the shut-off member 41. The diaphragm is delimited, at least partially, by a control chamber 44 of the shut-off member, and is fixed to an operating rod 45 connected to the shut-off member 41 for the purpose of moving the latter towards the position in which the pipe 42 is shut off, by means of the pressure exerted by the gas introduced into the control chamber 44, in opposition to the resilient return action of a spring 46.

The control chamber is in fluid communication, through a pipe 47, with a section 48 of an auxiliary pipe 49. The auxiliary pipe 49 includes a first portion 49a of pipe, which extends upstream of the section 48 to feed gas to the control chamber 44, and which is branched from the pilot pipe 16a. Alternatively, the portion 49a can be branched directly from the main pipe 2.

The pipe 49 includes a second portion 49b, extending in continuation of the first portion 49a, downstream of the section 48, for discharging gas from the control chamber 44 to the proximity of the pilot burner.

In the second portion 49b, downstream of the section 48, there is a valve 50, with a corresponding shut-off member 50a and a corresponding valve seat 50b, to enable the discharge portion 49b to be selectively opened or shut off.

Additionally, the discharge portion 49b, downstream of the valve 50, is connected to the pipe of the discharge line 9c, leading to the pilot and main burners, through a connecting pipe 49c.

In a preferred example, the valve 50 is an electromagnetically operated solenoid valve for opening and closing the corresponding valve seat 50b. In another exemplary embodiment, the solenoid valve 50 is pulse operated. Alternatively, the shut-off member 50a can also be provided with an operating rod driven by a stepping motor.

The numbers 51 and 52 indicate respective switches which are associated for operation with the shut-off member 41 and which are actuated by the latter in the corresponding closed and open positions of the discharge pipe 42 to generate corresponding signals for the control circuit of the device. The signals generated by the switches 51, 52 are transferred in a suitable way to the control unit 24.

In operation, the procedure for igniting the pilot burner 16 is conventional and includes the activation of the magnetic safety unit 20 (by means of the voltage generated by the thermocouple 22), to allow gas to flow along the pilot pipe 16a, followed by the ignition of the pilot burner. In this condition, the flow of gas in the main pipe is shut off, mechanically or electrically. Moving the knob 20d to the ON position enables the automatic regulation system of the electronic circuit board 24.

When a request for heat is made by acting on the knob 23, the valve seat 50b of the control circuit of the draft shut-off device 40 is initially opened (by the excitation of the solenoid valve 50), thus discharging the control chamber 44 and consequently causing the shut-off member 41 to return (by the resilient action of the spring 46) to the open position in the pipe 42.

This position is detected by the switch 51, which enables the solenoid valves 7 and 13 to be excited in order to open the corresponding valve seats 5a and 6a, thus causing gas to be supplied through the main pipe 2 to the main burner 4a.

When the request for heat has been met (for example, when the set temperature has been reached), the servovalves 5 and 6 are operated to close the main gas pipe, thus turning off the main burner. The next step in the operating logic is the closure of the shut-off member 41 of the draft shut-off device, after a specified time delay for example, by the de-energizing of the solenoid valve 50, which causes gas to accumulate in the control chamber 44, thus moving the shut-off member 41 to the closed position, this position being detected by the switch 52 when it is reached.

In this step, heat recovery is achieved by shutting off the fume exhaust pipe 42, thus impeding heat losses from the pipe 42, by known methods relating to the use of draft shut-off devices of this kind, also known as “flue dampers”. It should also be noted that the two servovalves 5, 6 are both designed as safety valves for shutting off the main gas passage, independently of the pilot burner line. This feature is necessary in the application described here, since both of the servovalves must act as automatic safety valves which can close the gas line regardless of the presence or absence of a flame at the pilot burner. The device according to the present invention is capable of closing both servovalves even if a flame is present at the pilot burner.

It should also be noted that the gas conveyed in the discharge pipes (otherwise known as “bleed lines”) from the control chambers 17 and 44, for the second servovalve 6 and the pneumatic draft shut-off device 40 respectively, is sent to the proximity of the pilot burner so as to be burnt by the corresponding flame.

Finally, it should be noted that the draft shut-off device according to the invention can also be used appropriately in valve units in which manual activation of the magnetic unit is not specifically provided for; for example, it can be used in a valve device in which the magnetic safety unit can be activated electrically (as well as manually), for what is known as “intermittent pilot” operation.

The invention achieves the proposed objects while yielding the aforementioned advantages by comparison with the known solutions.

1. A device for controlling the supply of a combustible gas to a burner, having a draft shut-off device in an exhaust pipe for the combustion fumes, comprising a main gas supply pipe in which are positioned a first and a second servovalve, in cascade with each other, with respect to a direction of flow of the gas, the servovalves including respective valve seats associated with corresponding shut-off members with diaphragm control for opening of the seats in opposition to respective resilient return members,
the first and second servovalves including respective first and second electromagnetically operated solenoid control valves for controlling opening and closing of the corresponding servovalves, the solenoid valves configured to operate by opening and closing pipes of corresponding servo-assisted control circuits, in such a way that the corresponding shut-off members of the corresponding servovalves are controlled indirectly, by the diaphragm controls, in order to put the main pipe in fluid communication with corresponding control chambers of the servovalves, one side of the diaphragm of each of the diaphragm controls being subjected to a pressure established in the corresponding control chamber,
a pilot pipe is branched from the main pipe upstream of the servovalves for supplying a pilot burner,
the main pipe being provided, upstream of the servovalves, with a magnetic thermoelectric safety unit with a manual activating knob, which acts on the pilot pipe to allow gas to flow to the pilot burner during activation of the unit,
the draft shut-off device comprises a corresponding shut-off member which is movable from and towards a position in which the fume exhaust pipe is shut off, and diaphragm-controlled pneumatic actuator of the shut-off member, the diaphragm forming, at least partially, a corresponding control chamber of the shut-off member which is connected to and in fluid communication with a section of an auxiliary pipe branched from the main pipe, a first portion upstream of the section being provided for the supply of gas to the control chamber and a second portion, which is an extension of the first portion, being provided downstream of the section for the discharge of the gas from the chamber in the proximity of the pilot burner;
a corresponding valve is provided on the discharge portion of the auxiliary pipe, downstream of the section, for selective control of opening or shut-off of the discharge portion.

2. A device according to claim 1, wherein the first portion of auxiliary pipe for supplying the gas to the control chamber of the shut-off member relating to the control shut-off device is connected to the main pipe by means of fluid communication with the pilot pipe leading to the pilot burner.

3. A device according to claim 1, wherein the valve on the auxiliary discharge pipe is an electromagnetically operated solenoid valve for controlling opening and closing of the corresponding valve seat.

4. A device according to claim 1, wherein the flow of gas conveyed through said portion of discharge pipe is directed to the flame of the pilot burner and is burnt by a pilot flame.

5. A device according to claim 1, wherein the actuator comprises a shut-off member control rod which can be fixed to the diaphragm of the corresponding control, so as to be moved, by a pressure of the gas supplied to the corresponding control chamber and acting on one side of the diaphragm, in opposition to the action of a resilient return member, from and towards an operating position in which the corresponding shut-off member shuts off the fume exhaust pipe.

6. A device according to claim 3, wherein the solenoid valve is pulse controlled.

7. A device according to claim 1, wherein the valve is provided with a shut-off member having a control rod driven by a stepping motor.
